(19) United States
(12) Patent Application Publication
(10) Pub. No.: US 2010/0205025 A1
(43) Pub. Date: Aug. 12, 2010

(54) Innovation management

(75) Inventor: Alf Martin Johansen, Hovik (NO)

Correspondence Address: NIXON & VANDERHYE, PC, 901 NORTH GLEBE ROAD, 11TH FLOOR, ARLINGTON, VA, 22203, US

(73) Assignee: Induct Software AS, Oslo (NO)

(21) Appl. No.: 12/656,464

(22) Filed: Jan. 29, 2010

Related U.S. Application Data
(60) Provisional application No. 61/202,139, filed on Jan. 30, 2009.

(30) Foreign Application Priority Data
Sep. 16, 2008 (NO) 2008 3946

(51) Int. Cl. G06Q 10/00; G06F 15/16; G06F 17/30

(52) U.S. Cl. 705/7; 709/204; 707/748; 707/769; 707/E17.014

(57) ABSTRACT

A system for management of ideas in a community is provided that includes a database with updatable user profiles for users of the community and means for receiving ideas from users. The system further includes means for receiving input providing information about the idea, means for handling and categorizing the ideas adapted to use the input, means for providing a set of process steps based on the categorization, means for storing the received, handled and categorized ideas, means for distributing the ideas to the other users of the community and means for enabling the users to process and evaluate the ideas.

### CROSS-REFERENCE TO RELATED APPLICATION

This application claims the benefit of Provisional Application No. 61/202,139, filed Jan. 30, 2009, the entire content of which is hereby incorporated by reference in this application.

### FIELD OF THE INVENTION

The present invention relates to enabling people inside an organization (and outside if invited) to collaborate with one another across locations, hierarchy and departments, in a virtual innovation community, facilitating multiple innovation processes, including an advanced ranking engine to ensure portfolio management and reporting capabilities.

### BACKGROUND OF THE INVENTION AND PRIOR ART

Because of rapid environmental changes and globalization of the world economy, innovation processes have become a core business process to drive organization's performance. In addition, innovation methodology is developing, and leading scientists are talking about innovation within several fields (i.e. product, process, organization, service, business model etc). It has become increasingly difficult for organizations to create the flexibility needed to sustain a certain quality of innovation management.

Present systems for managing an innovation process are typically transaction based systems built on product innovation methodology. These systems are used by a few selected employees within an organization, usually only innovation departments or employee(s) with responsibility for innovation. Visibility and collaboration between employees outside of the innovation group is very limited, or in most organizations not possible. Some organizations use idea post boxes or a specific e-mail address where employees or other people can input or send their ideas. However, there are very limited possibilities for following your ideas in the innovation process, and misunderstandings or conflicts can easily happen. There is no single existing innovation management system that handles the whole process from idea generation to commercialization of the idea. Most existing systems stops after the idea has been generated and stored.

Thus, there is a need for a flexible, end-to-end solution to ease innovation management, where different types of innovation (i.e. product, process, organization, service, business model etc.) can be directed into the right process and then follow the correct steps towards commercialization. Further, there is a need for a system that enables organizations to easily include all employees in the innovation community, both for information purpose and participation in developing ideas and resolving challenges. Some people in the community are idea creators, some are problem solvers, while others are good at carrying out tasks and accomplishing processes. By bringing them together, innovation can happen.

### OBJECTIVE OF THE INVENTION

It is thus an object of the present solution to provide a system and a method for flexible innovation and talent management that also enables organizations to perform portfolio management of ideas and challenges for all types of innovation. Another object of the present invention is to structure innovation processes from idea creation to implementation and/or commercialization, and allow organizations to design and implement processes specially designed for them, quickly moving from idea to implementation and/or commercialization. The objects of this invention are obtained as described in the accompanying claims.

### SUMMARY OF THE INVENTION

The objectives set forth above are achieved by providing, in a first aspect of the present invention, a system for management of ideas in a community. The system comprises a database comprising updatable user profiles for users of the community and means for receiving ideas from users. The system further comprises means for receiving input providing information about the idea, means for handling and categorizing the ideas adapted to use the input, means for providing a set of process steps based on the categorization, storage means for storing the received, handled, and categorized ideas, means for distributing the ideas to the other users of the community, and means for enabling the users to process and evaluate the ideas.

In an alternative embodiment of the system according to the invention, the input comprises a text string describing the idea and a selection from a predetermined list. This combines the description of the idea and the selection of type of innovation to provide a selection of innovation process adapted to the particular idea and company.

In another alternative embodiment of the system according to the present invention, the predetermined list is constituted by types of ideas. This provides the user with the choice of placing his/her idea in a category describing types of innovation.

In yet an alternative embodiment of the system according to the invention, the means for receiving and processing ideas is adapted to rank the ideas according to evaluation from the users. Thus, the valuable and most promising ideas are prioritized before the ideas being outside the company's core business.

In an alternative embodiment of the system according to the present invention the ideas are ranked according to predetermined criteria. Each company using the present invention can define their own criteria that are valuable to them. In this way, the system becomes flexible and user-adjustable to fit all types of users. Ideas are highlighted to suit the company's goals and strategy.

In still an alternative embodiment of the system according to the present invention the system further comprises a means for providing a scorecard (also known as a ranking algorithm or evaluation form) comprising the predetermined criteria, the predetermined criteria is based on the categorization. These scorecards are basic for portfolio management functionality. With the scorecard, portfolio management accelerates identification of viable ideas, while ensuring non-viable proposed ideas are discontinued early. This will enable organizations to design, build, and customize their own innovation processes.

In yet an alternative embodiment of the system according to the present invention the system comprises means for evaluating the financial effect of the ideas. This provides the possibility to capture and summarize the net financial impact of all innovation related activities including time applied, out-of-pocket expenditures, implementation costs, rewards, cost-savings and revenues.

In still an alternative embodiment of the system according to the present invention the system further comprises means for subscription to ideas. Thus, the users can regularly get information on ideas and topics relevant and interesting for them, and not be disturbed by non-relevant topics.

In an alternative embodiment of the system according to the invention the system comprises means for tracking user activities to provide reward and recognition. Rewards and recognition tracks redemption for gifts, and awards or cash to ensure that key users in the innovation process are recognized and properly rewarded. This is also the basis of displaying a list of “Top Innovators” and to acclaim “This month's Innovator”.

In yet another alternative embodiment of the system according to the present invention the system is arranged to include users outside the community. This provides the capability to include, for example, external expertise not present in-house to provide an optimal innovation process within the expertise areas.

In still another alternative embodiment of the invention according to the present invention the user database is searchable to provide the functionality of searching for, e.g. a specific type of competence.

In a second aspect of the present invention, there is provided a method for management of ideas in a community, the method comprises the following steps:
creating a database comprising updatable user profiles for users of the community
receiving ideas from users,
receiving input providing information about the idea,
handling and categorizing the ideas by using the received input,
providing a set of process steps based on the categorization,
storing the received, handled and categorized ideas,
distributing the ideas to the other users of the community,
enabling the users to process and evaluate the ideas.

In alternative embodiment of the method according to the second aspect of the present invention, the input comprises a text string describing the idea and a selection from a predetermined list.

In still another alternative embodiment of the method according to the present invention the predetermined list is constituted by types of ideas.

In an alternative embodiment of the method according to the invention the step for receiving and processing ideas is adapted to rank the ideas according to evaluation from the users.

In still an alternative embodiment of the method according to the present invention the ideas are ranked according to predetermined criteria.

In yet still an alternative embodiment of the method according to the present invention the method further comprises the step of providing a scorecard comprising the predetermined criteria, the predetermined criteria is based on the categorization.

In another alternative embodiment of the method according to the present invention the method comprises the step of evaluating the financial effect of the ideas.

In still another alternative embodiment of the method according to the invention the method further comprises the step of subscription to ideas.

In yet another alternative embodiment of the method according to the present invention the method comprises the step of tracking user activities to provide reward and recognition.

In another alternative embodiment of the method according to the present invention the method is arranged to include users outside the community.

In still another alternative embodiment of the method according to the invention the user database is searchable.

### BRIEF DESCRIPTION OF THE DRAWINGS

The invention will now be described in more detail with references to the appended drawings wherein

FIG. 1 Illustrates an example of a screen display of “My Page”.

FIG. 2 Shows an overview of the idea process.

FIG. 3 Shows a detailed flow diagram for the idea process.

FIG. 4 Shows a flow diagram for creating scorecards.

FIG. 5 Illustrates an example of a screen display of “Idea Page”.

FIG. 6 Illustrates an example of a screen display of “Main Page”.

FIG. 7 Illustrates an example of a screen display of “Portfolio Management Page”.

FIG. 8 Illustrates an example of a screen display of “Scorecard”.

### DETAILED DESCRIPTION OF THE INVENTION

The present invention provides collecting, sharing and developing ideas and challenges (innovation) all over an organization, regardless of location, department, hierarchy or profession. In this context, a challenge can lead to several ideas, but does not have to lead to an idea(s), and an idea can arise without coming form a challenge. An idea or challenge is documented and tracked from creation to commercialization, and all activities, changes and notes will be kept for history and documentation of the development. In the community, ideas and challenges meet knowledge and experience.

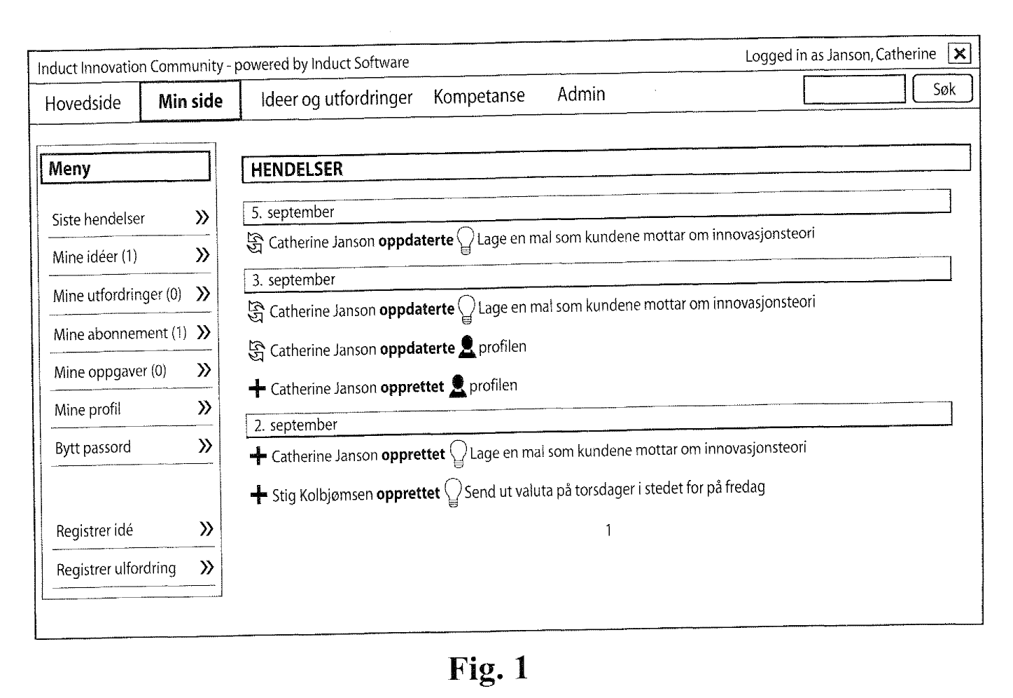

All members of the innovation community will create and update their own profile and have a personal page, containing information such as; personnel information, picture, work experience, education, skills, personal characteristics and personality type. An example of a personal page is shown in FIG. 1. This information is stored in a storage medium, for example a database. An example of a community can be an organization. Users in the community can consist of, for example, employees within an organization only, but can also include external people if desired, such as clients, suppliers, technology partners, professors etc. Integration of the user information with employee registers is possible, and HR databases can be imported into the system. Integration to other types of communities, such as LinkedIn, Facebook, etc. can also be imported into the system, so that the users do not have to type their contact information several times. All users can update and maintain their own knowledge and experience profile. The user can choose to become a member of different groups within the community. If the innovation community is for instance a car manufacturing company, an example of a group can be persons working with and interested in tires.

The personal page summarizes, as shown in FIG. 1, the users' activities, tasks, ideas, challenges and subscriptions. The users of the innovation community can through the personal page access ideas, challenges, tasks and all information they subscribe for. Also, through the personal page, people will be able to communicate with one another via messages or instant messaging. When updates happen on the personal page, the user will receive an e-mail, notifying him/her what has happened, and provide a link for direct access to the update.

The system will be set up with standard roles. However, an organization can customize and add as many roles as they would like, and grant access control and views according to their existing models and thresholds. Access control can even be granted down to single documents if desired. To be able to log on to the system, members of the innovation community need to be set up with a user account and password, which can be synchronized with existing user control applications (i.e. active directory etc.)

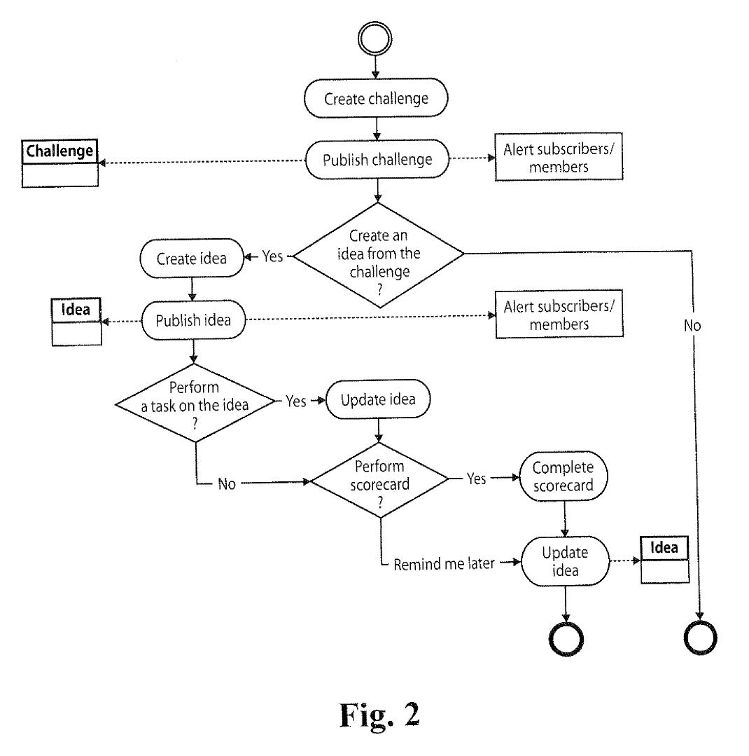

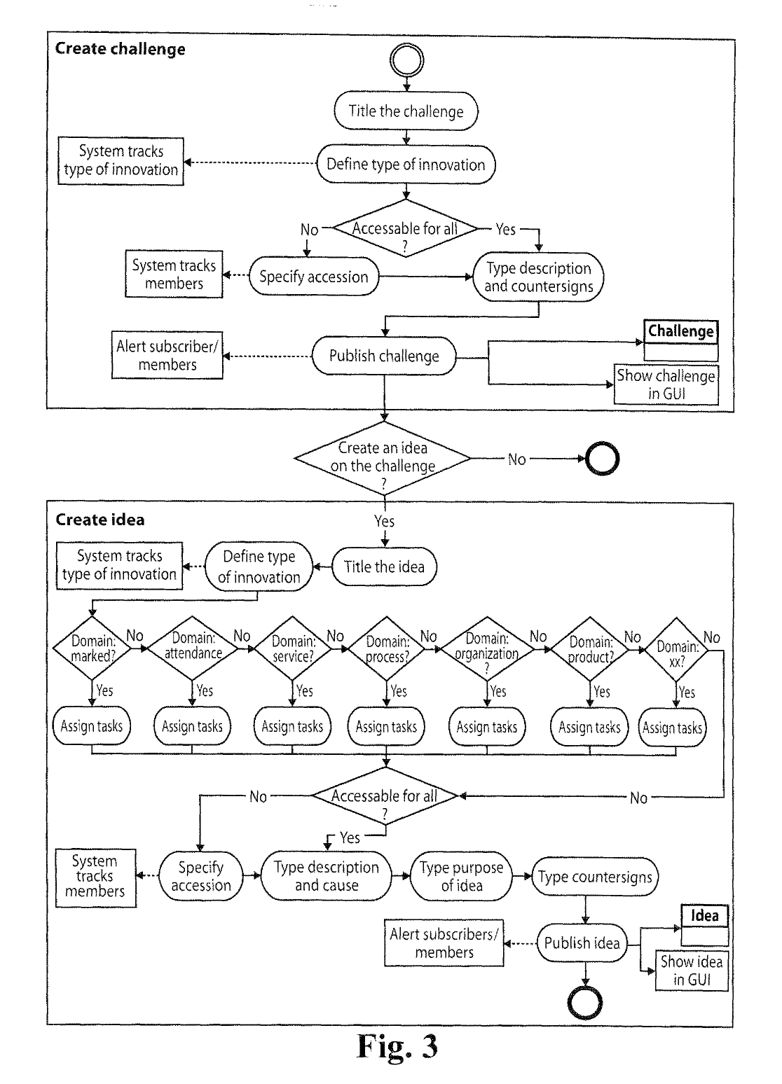

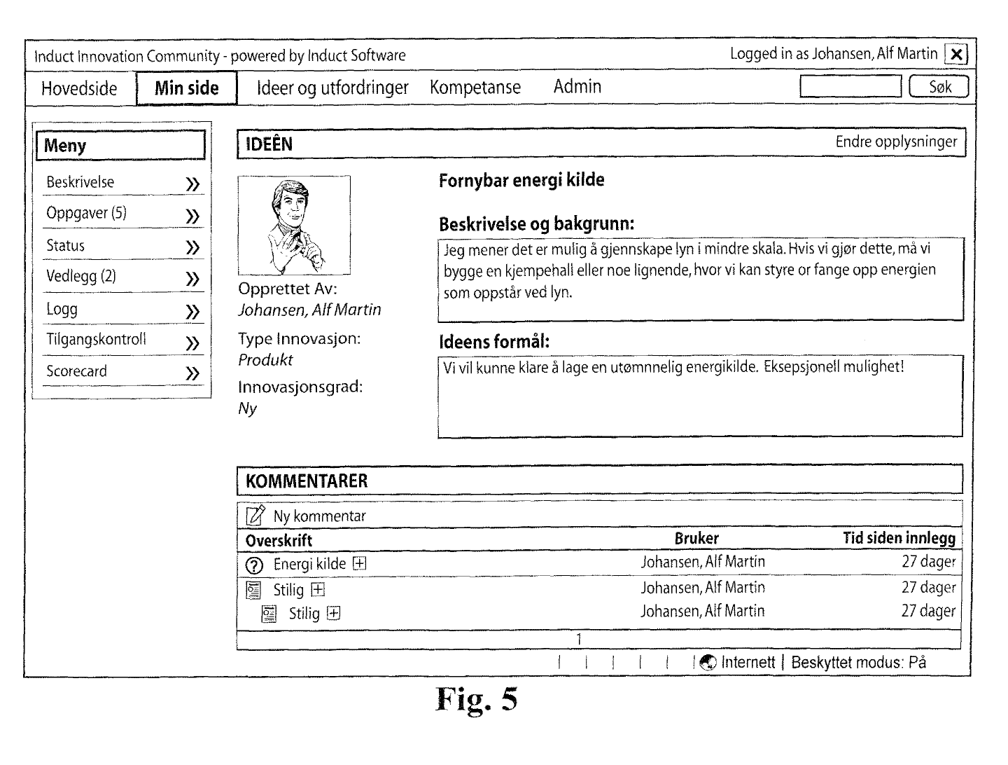

FIG. 2 shows an overview of the idea process, from creation of a challenge to the final idea, and FIG. 3 shows a detailed flow diagram of the same process. A user creates a challenge, for example that there is a need for a new type of pattern on tires that can handle snow conditions better. The creator of the idea defines a title of the idea, the type of innovation that the challenge belongs to etc. When the title is entered, a cross connection is automatically created to existing ideas related to this new idea. In the tire example, the challenge is a product type of innovation. In addition to the type of innovation, the user makes a description of the challenge, and can add attachments related to the challenge. The user/creator of an idea or challenge can choose to make the idea or challenge visible for all or for a specific group. Each idea/challenge has its own page, as for example shown in FIG. 5. When an idea or challenge has been posted, an e-mail will automatically be sent to the specific group, for example the tires-group, with information about the initiative. If it is visible for all in the organization, for example the whole car manufacturing company, an e-mail will be automatically sent to those who subscribe to certain key words or innovation categories. This e-mail contains a link where the user clicks for direct access to the initiative. When an idea or challenge has been posted, users can comment or ask questions to further develop the initiative. Both an idea and a challenge have their own site, where description, attachments, dialogues, access control, process roles and status can be updated. The system is adapted to track who is the creator of the ideas and which challenge or idea leads to new ideas. This can again be connected to a reward and recognition system.

A challenge can lead to several ideas and will be closed when the creator of or person responsible for the challenge accepts one or more of the ideas as a solution to the challenge. As mentioned above, when a user of the innovation community creates an idea, an innovation type has to be chosen (i.e. product, process, organization, service, business model etc). In addition, the user inputs a text description of the idea. The chosen innovation type together with the words in the text description will lead the initiative into the correct process designed for that specific innovation type. This means that every innovation type has its own process life cycle. A set of standard innovation processes is included in the system. However, an organization can design their own processes and link these processes to different innovation types (i.e. product, process, organization, service, business model etc). It is possible to define several sets of default tasks and templates which can be assigned to the steps in the standard innovation processes to ensure compliance and speed of the processes. The system contains a flexible task management module to ensuring all tasks are assigned to participants and accomplished within time limits. All tasks have to be approved by participants before the task is formally assigned. The process engine makes it possible to define innovation type(s) with flexible numbers of gates and stages, where steps, goals and tasks in the process can be defined “as you go.” All documentation and communication are allocated to the specific task. It is possible to let all members of the innovation community visibility into the idea and process, or keep it secret if necessary (i.e. patent applications). Process management ensures that on-going initiatives are strategically aligned and stay on-track throughout the implementation process.

To develop an idea, a team can be assigned and responsibilities distributed among team members. With basis in the member's profiles, the team can search for competence and ask specific team members to participate in the whole process or to solve specific task or challenges. On the other hand, users of the innovation community can sign up and offer their expertise in interesting ideas, or the team of an idea can post a vacant position or task to be completed. Users of the innovation community who are interested in an idea or challenge can subscribe to be updated on activities or what happens on these initiatives. A user's own ideas, challenges and subscriptions will appear on his/her “home page” and recent happenings will be presented there. When an idea or challenge is “closed” or “implemented,” it will be available in the library for history or as a knowledge database.

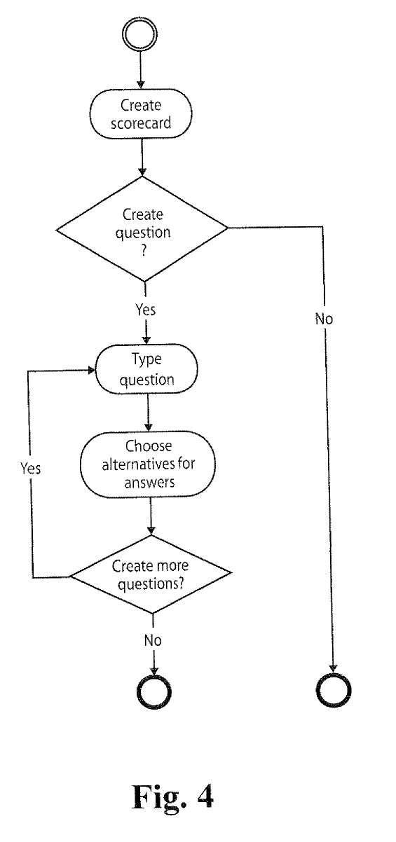

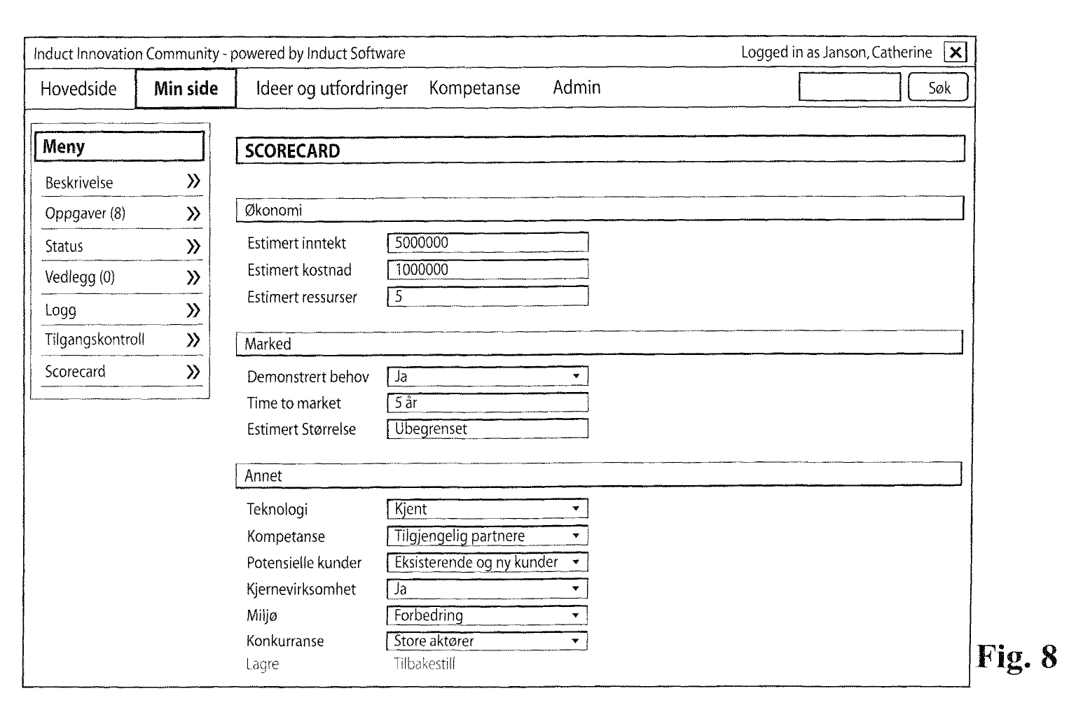

A set of criteria will be available for each idea to be completed. An organization can specify multiple sets of criteria and connect these sets of criteria to innovation types (i.e. product, process, organization, service, business model etc). These criteria will be used by a configurable ranking engine to allow members in the innovation community to identify the most promising innovations in an organization. Each user can choose criteria for filtration and ranking according to their preferences and needs. Scorecards specially designed for different innovation types can be attached to ideas, and these scorecards are basic for portfolio management functionality. The process for providing a scorecard can be seen in FIG. 4 and an example of a screen shot of a scorecard can be seen in FIG. 8. It is possible to weight criteria to highlight ideas suited to user goals and strategy. With the scorecard, portfolio management accelerates identification of viable ideas, while ensuring non-viable proposed ideas are discontinued early. This will enable organizations to design, build and customize their own innovation processes. Several processes can be designed, and unique processes can be linked to different innovation types (i.e. product, process, organization, service, business model etc.). Through process management, specific tasks can be pre assigned to ideas and made mandatory dependent on chosen innovation type. It is also possible to apply an open process, were milestones, tasks and decision gates will be added during the evolution of the idea.

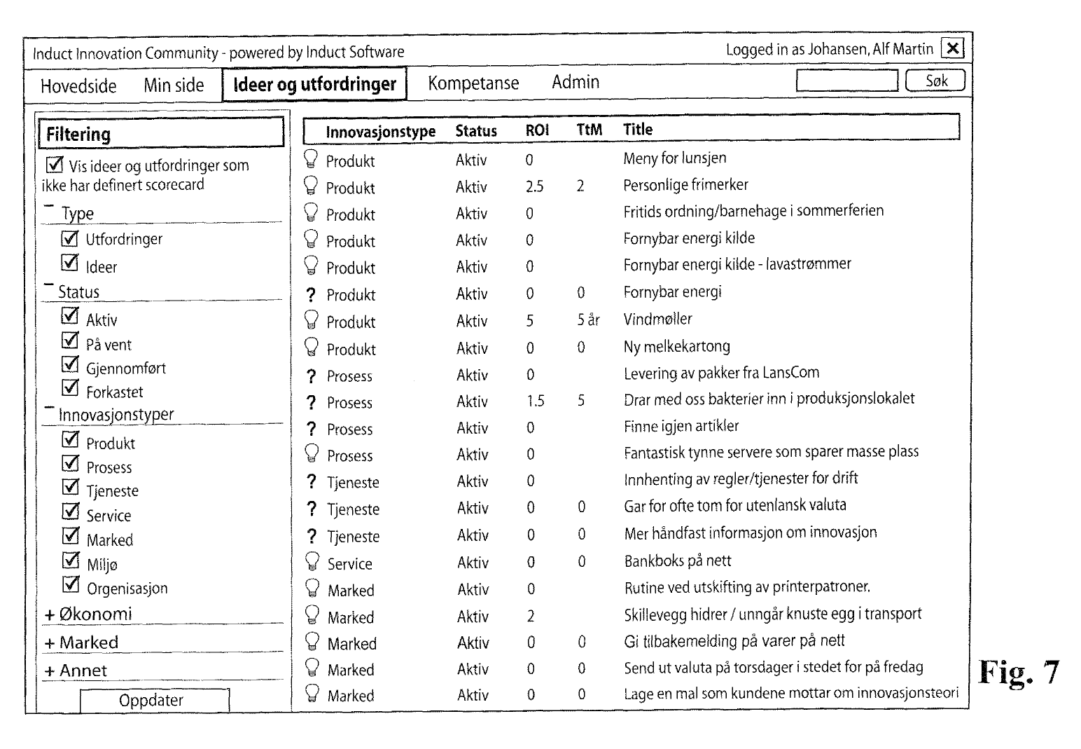

Portfolio management can be used on all ideas and challenges. However, small incremental ideas (i.e. process change) can be routed outside the standard innovation pipeline gates and accomplished without involvement of portfolio management. The system according to the present invention increases visibility and reduces risk assigned to innovation initiatives, where non-valuable ideas can be stopped and/or valuable ideas can be found and developed. Depending on the user's responsibilities or interests, he/she will be able to choose ideas based on the criteria from the scorecard and weight the criteria according to his/her focus. This enables an organization to perform portfolio management, were innovation initiatives can be balanced, measured and reported on a consolidated basis within large groups. Portfolio management can be visualized for example in the screen shot shown in FIG. 7. In this figure, the company's idea/challenge portfolio is visible.

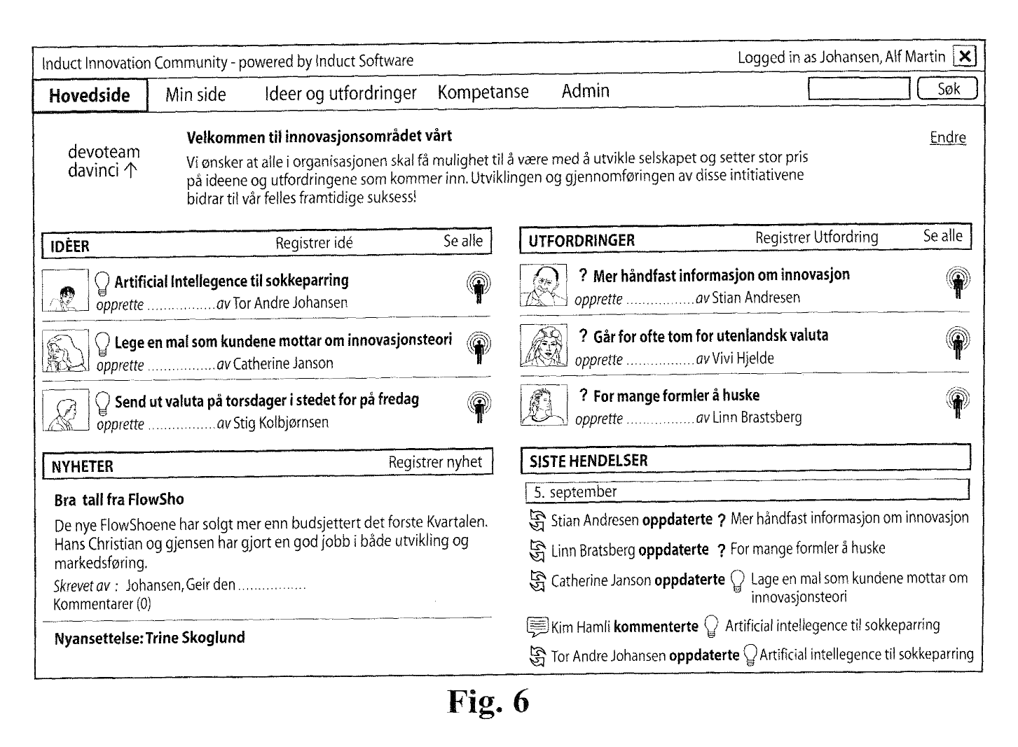

The system will comprise a module for posting innovation news and market intelligence on a “Main Page” for information sharing. An example of a screen shot of the “Main Page” is shown in FIG. 6. It is also possible to comment, ask questions and generate a dialogue based on the posted information. This module enables members of the innovation community to track and discuss emerging trends, competition and areas of opportunity.

The system also comprises an easy-to-use search function which allows users of the innovation community to locate experts for help with ideas, challenges or questions. However, members of the innovation community can choose not to be contacted or available for participation in developing ideas or challenges.

The system is adapted to track user's individual contribution. Points are accumulated for selected activities and achievements as for example in “Frequent Flyer Programs,” and a statement is available in the user's personal page. Rewards and recognition tracks redemption for gifts, awards or cash to ensure that key users in the innovation process are recognized and properly rewarded. This is also the basis of displaying a list of “Top Innovators” and to acclaim “This month's Innovator.”

The system according to the present invention also comprises a financial module which can be integrated with financial systems of the organization, or information can be entered into the innovation community system. It provides the possibility to capture and summarize the net financial impact of all innovation related activities including time applied, out-of-pocket expenditures, implementation costs, rewards, cost-savings and revenues. Other key innovation performance indicators can also be tracked, such as number of ideas, value of ideas, time spent on innovation activities and other indicators specified or requested by clients. An innovation pipeline is displayed visualizing the value and number of ideas within innovation types chosen by the user.

The system is also adapted to integrate with different types of applications, such as personality tests, mind maps, living lab, virtual meeting rooms etc.

All information is stored in a permanent, searchable archive. The archive has a record of all communication, documents, postings, ideas, challenges, tasks, questions and decisions. The information stored in the library can be pushed when new ideas, challenges etc. are entered on a “most relevant” basis and ensure better use of existing work, documents, knowledge and experience. The library of ideas and challenges ensures that ideas can be reused, and do not have to be “re-invented” several times within an organization or get access to previously solved challenges.

In summarized, the present invention is an environment where members in a community, with different skills and knowledge, can collaborate efficiently and increase utilization of human capital and the speed of organizational evolution. This facilitates an environment where radical innovations occur, where people meet other people they would not meet or talk to outside the innovation community. It also increases collaboration and employee involvement and reduce collaboration cost. Also, by enabling all employees to take part in innovation initiatives, the organization will take maximum advantage of existing talents and human capital, and increase employee satisfaction.

What is claimed is:

1. System for management of ideas in a community, the system comprising:
a database with updatable user profiles for users of the community, and
means for receiving ideas from users, wherein the system further comprises:
means for receiving input providing information about the idea,
means for handling and categorizing the ideas adapted to use the input,
means for providing a set of process steps based on the categorization,
means for storing the received, handled and categorized ideas,
means for distributing the ideas to the other users of the community, and
means for enabling the users to process and evaluate the ideas.

2. System according to claim 1, wherein the input comprises a text string describing the idea and a selection from a predetermined list.

3. System according to claim 2, wherein the predetermined list is constituted by types of ideas.

4. System according to claim 1, wherein the means for receiving and processing ideas is adapted to rank the ideas according to evaluation from the users.

5. System according to claim 4, wherein the ideas are ranked according to predetermined criteria.

6. System according to claim 5, wherein the system further comprises means for providing a scorecard comprising the predetermined criteria, the predetermined criteria is based on the categorization.

7. System according to claim 1, wherein the system comprises means for evaluating the financial effect of the ideas.

8. System according to claim 1, wherein the system further comprises means for subscription to ideas.

9. System according to claim 1, wherein the system comprises means for tracking user activities to provide reward and recognition.

10. System according to claim 1, wherein the system is arranged to include users outside the community.

11. System according to claim 1, wherein the user database is searchable.

12. Method for management of ideas in a community, the method comprises the following steps:
creating a database comprising updatable user profiles for users of the community
receiving ideas from users,
wherein the system further comprises the steps:
receiving input providing information about the idea,
handling and categorizing the ideas by using the received input,
providing a set of process steps based on the categorization,
storing the received, handled and categorized ideas,
distributing the ideas to the other users of the community, and
enabling the users to process and evaluate the ideas.

13. Method according to claim 12, wherein the input comprises a text string describing the idea and a selection from a predetermined list.

14. Method according to claim 13, wherein the predetermined list is constituted by types of ideas.

15. Method according to claim 12, wherein the step for receiving and processing ideas is adapted to rank the ideas according to evaluation from the users.

16. Method according to claim 15, wherein the ideas are ranked according to predetermined criteria.

17. Method according to claim 16, wherein the method further comprises the step of providing a scorecard comprising the predetermined criteria, the predetermined criteria is based on the categorization.

18. Method according to claim 12, wherein the method comprises the step of evaluating the financial effect of the ideas.

19. Method according to claim 12, wherein the method further comprises the step of subscription to ideas.

20. Method according to claim 12, wherein the method comprises the step of tracking user activities to provide reward and recognition.

21. Method according to claim 11, wherein the method is arranged to include users outside the community.

22. Method according to claim 12, wherein the user database is searchable.
